(19) United States
(12) Patent Application Publication
(10) Pub. No.: US 2009/0013922 A1
(43) Pub. Date: Jan. 15, 2009

(54) AUTOMOBILE PROJECTED LIGHT FOR LIFE SAFETY

(76) Inventor: Yung-Fa LIN, Banqiao City (TW)

Correspondence Address: RABIN & Berdo, PC, 1101 14TH STREET, NW, SUITE 500, WASHINGTON, DC, 20005, US

(21) Appl. No.: 11/777,444

(22) Filed: Jul. 13, 2007

(51) Int. Cl. B60Q 1/26

(52) U.S. Cl. 116/28 R

(57) ABSTRACT

The invention relates to an automobile projected light for life safety, comprising a casing, a projected light source and a lens body, which are installed on either inside or outside of an automobile. The lens body has a lens provided therein and the projected light source is installed on the rear area of the lens, thereby enabling the projected light to become a kind of warning light, character or sign picture after the light passes through the lens. Accordingly, the invention enables different warning characters, signals of calling for help or even ads. to be projected.

### BACKGROUND OF THE INVENTION

I. Field of the Invention

The present invention relates to an automobile projected light for life safety, especially to a projected driving safety light that is installed on a motor vehicle and able to connect the vehicle road light circuits. It enables a warning character or a sign picture to be projected on the roadway or car window during the movement of the vehicle, such as signals of turning to the left or right direction, applying the brakes to stop a vehicle, showing breakdown status or calling for help, etc. thus to prevent a driver from possible car accident.

II. Description of the Prior Art

Generally, a conventional automobile has equipped with turn signals, brakelights, and warning triangles for vehicle breakdown. Basically, an automobile with said equipment is considered sufficient for a driver to handle all kinds of safety situations during his driving. Nevertheless, there are more and more vehicles on the road than before and the driving speed at present time is also faster than in the past; in addition, there is always some dead angles for a driver to watch out when he is driving. Namely, the conventional automobile standard equipment becomes insufficient for modern time driving; the invention, therefore, provides driving warning equipment for said automobile to enhance the driving safety.

### SUMMARY OF THE INVENTION

In view of the foregoing drawbacks of said conventional automobile driving warning equipment, an innovative “automobile projected light for life safety” is therefore disclosed hereafter.

The main objective of the present invention is to provide an automobile projected light for life safety that is able to connect the automobile the vehicle road light circuits and simultaneously respond to a driver's automobile operation (such as activating a turn signal, applying the brakes, flashing warning lights when stopping at roadside) to automatically project a warning light, character or sign picture on window or ground for the driver, so as to increase driving safety on the road.

To achieve said objectives, the invention mainly comprises a casing, a projected light source and a lens body, which are installed on either inside or outside of an automobile to project light on window or ground; the characteristic of the invention lies in that the lens body has a lens provided. The projected light source is installed on the rear area of the lens, thereby enabling the projected light to become a kind of warning light, character or sign picture after the light passes through the lens.

When a signal is received or the vehicle power is turned, the projected light source is then turned on immediately and the light is transformed into a geometric line, character or sign picture. It can be seen on an area that is visible by others, such as on the automobile window, or on the ground of either lateral sides or rear of the vehicle after the projected light source passes through the lens body on the front thereof, the light is able to be driving safety light such as signals of turning to the left or right direction, applying the brakes to stop a vehicle, showing breakdown status or calling for help, etc. In addition, the projected light has the magnification effect to enable other drivers keep out of the way on the road, the invention provides another light source over an standard automobile light system for other drivers nearby during driving to watch out and other drivers, thus having more time to respond. Therefore, as to assure driving safety; the invention further enables different warning characters, signals of calling for help or even ads. to be projected.

### BRIEF DESCRIPTION OF THE DRAWINGS

FIG. 1 is a three-dimensional exploded view showing a preferred embodiment of the invention;

FIG. 2 is an overlook view showing the application of the preferred embodiment of FIG. 1;

FIG. 3 is an overlook view showing another application of the preferred embodiment in accordance with the invention;

FIG. 4 is a three-dimensional exploded view showing another preferred embodiment of the invention; and

FIG. 5 is a three-dimensional exploded view showing another preferred embodiment of the invention.

### DESCRIPTION OF THE PREFERRED EMBODIMENT

Further aspects, objects, and desirable features of the invention will be better understood from the detailed description and drawings that follow in which various embodiments of the disclosed invention are illustrated by way of examples.

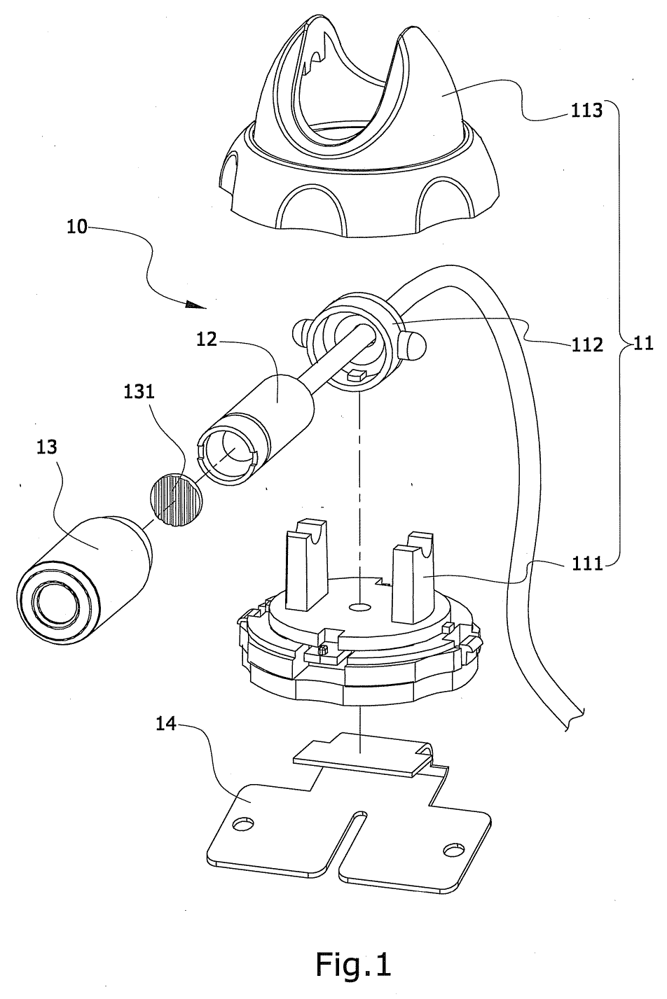

With reference to FIG. 1, an automobile safety projected light 10 of the invention mainly comprises a casing 11, a projected light source 12 (LED diode, laser diode) and a lens body 13, which are installed on either inside or outside of an automobile to project light on window or ground; the characteristic of the invention lies in that the lens body 13 has a lens 131 provided therein and the projected light source 12 is installed on the rear area of the lens 131, thereby enabling the projected light to become a kind of warning light, character or sign picture after the light passes through the lens 131.

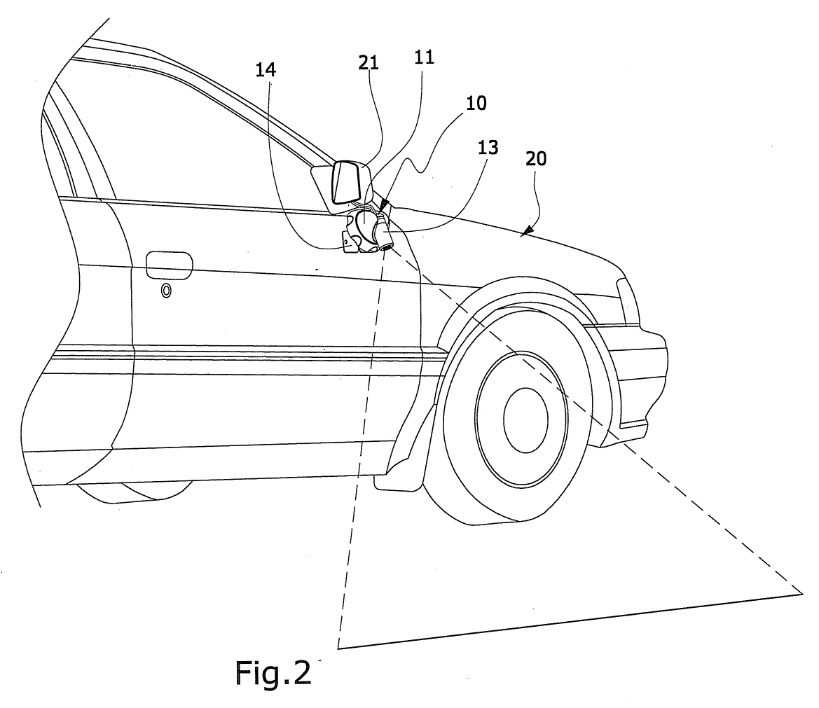

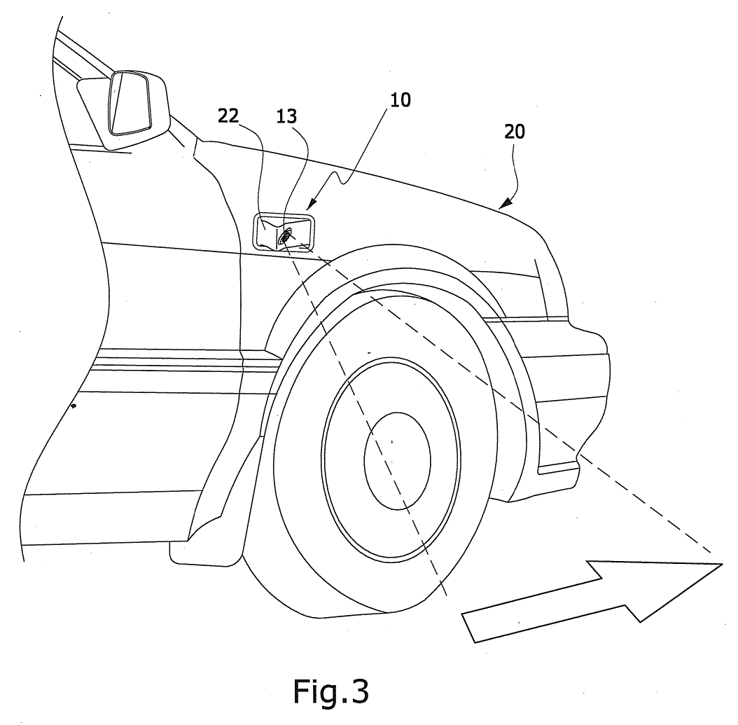

With reference to FIG. 1, the lens 131 is a cylindrical lens with a plurality of parallel cylindrical modes thereon, thereby enabling the light from the projected light source 12 to be transformed into a stream of line on the ground 30. Moreover, the lens body 13 in the embodiment is provided on the casing 11, able to be adjusted for light projection angle and either mounted by a metal seat 14 or stuck on appropriate area of an automobile 20 (such as applying the structure in FIG. 1 to be installed in the vicinity of a rearview mirror 21 as shown in FIG. 2, or as shown in FIG. 3 that directly using a sidelight hood 22 on an automobile 20 as the casing of the automobile safety projected light 10, enabling the lens body 13 with the projected light source mounted therein to be assembled together), at the same time, enabling the wire of the projected light source 12 set on the rear of the lens body 13 to connect relevant circuits of the automobile 20, or enabling separate switch to be connected for use.

The casing 11 in this embodiment comprises a stand 111, a mirror mount 112 and a outer covering 113, wherein the mirror mount 112 is pivotally set on the stand 111, covered by the outer covering 113 and set with the stand 111 in one piece, the projected light source 12 is installed inside the lens body 13, subsequently, pierced through the mirror mount 112 and mounted inside thereof, and finally positioned inside the casing 11.

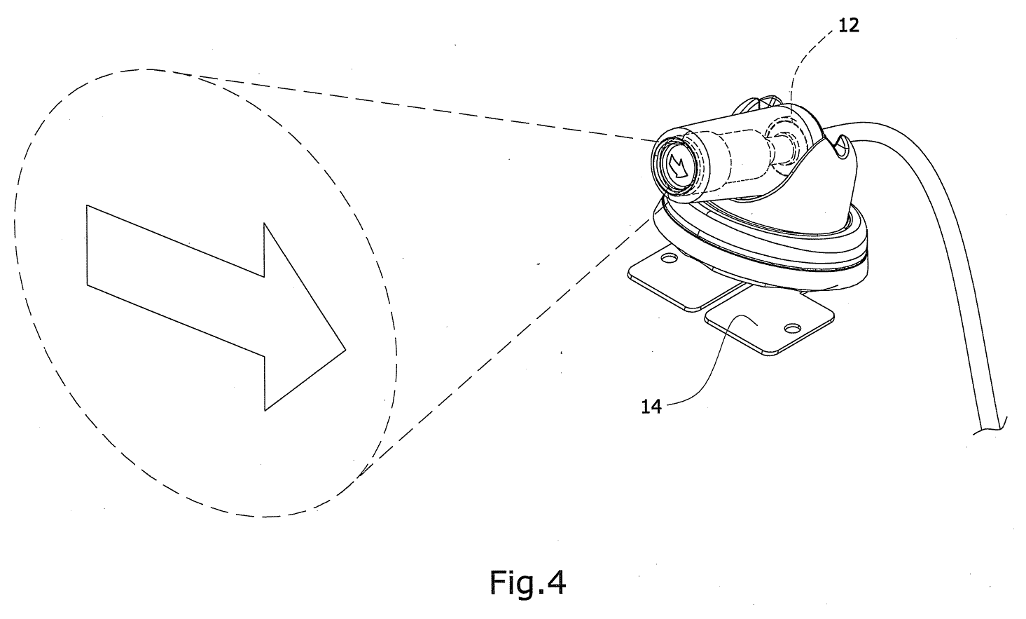

With reference to FIG. 4, the lens 131 is a convex lens with a hollowed-out (pervious to light) character or sign picture printed or affixed on the surface thereof (i.e., making the area outside a character or a sign is opaque, or the area of a character or a sign is opaque). In this embodiment, the invention applies a directional sign as an example to turn the light from the projected light source 12 to be an arrow-like sign on the ground or window (windshield on the rear of the vehicle).

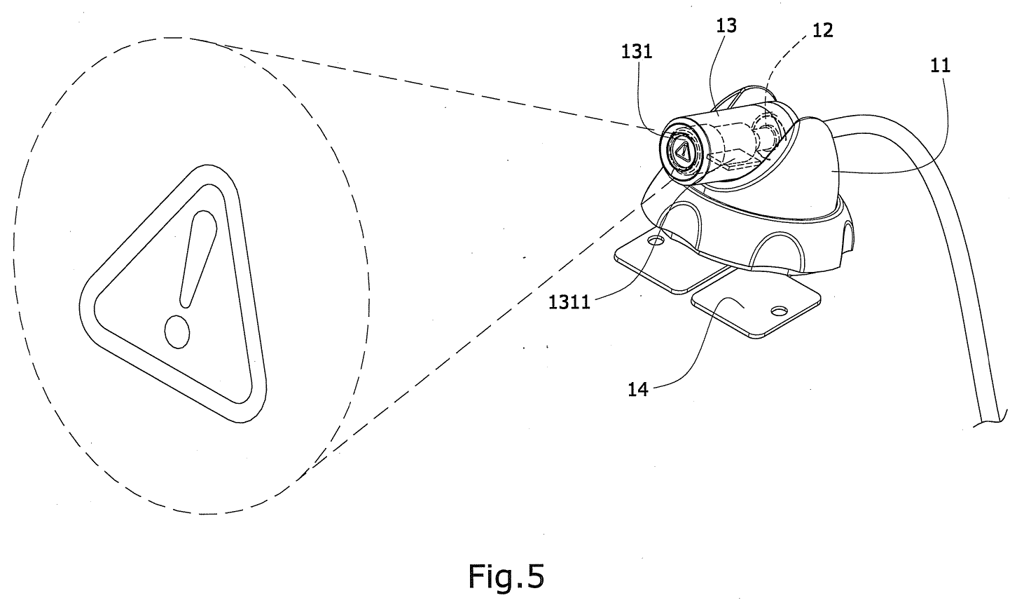

With reference to FIG. 5, the lens 131 is a LCD monitor pervious to light, a character or picture through the lens 131 (the sign shown in the FIG. 5 is a triangle warning sign) is displayed by an integrated circuit 1311, therefore, said character or sign picture is able to be altered and projected on visible area of the rear window of an vehicle according to various computer program design and different inputted signals. The invention further enables variable animations to be designed and shown through the lens, so as to enable the automobile safety projected light 10 to display a variety of effects, such as signals of turning to the left or right direction, showing breakdown status, SOS signal of calling for help, etc., and even more, the invention enables a car phone or other merchandise item or trademark to be displayed, so as to enhance the practicability of the invention.

In this embodiment, when the automobile safety projected light 10 of the invention receives a turn-on signal or a driver starts the vehicle to enables the vehicle circuits to be activated, the projected light source 12 is then immediately lighted and the light from the projected light source 12 turns from original dot-like or cylindered streams of light into a geometric line (horizontal line), character or sign picture, such as signals of turning to the left or right direction, applying the brakes to stop a vehicle, showing breakdown status or calling for help, etc. (as shown in FIGS. 2˜5), to be displayed on the ground of either lateral sides or rear of the vehicle of the automobile 20 that is visible by others after passing through the lens body 13 on the front. In addition, the projected light has the magnification effect to enable other drivers keep out of the way on the road, the invention provides another light source over an standard automobile light system for other drivers nearby during driving to watch out and other drivers have more time to respond so as to assure driving safety; the invention further enables different warning characters, signals of calling for help or even ads. to be projected.

To sum up, the “automobile projected light for life safety” of the invention is a driving light certainly enabling to enhance driving safety, and even more, show signal of calling for help or various ads. required, so that the invention has the effects of practicability and economical value at the same time.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An automobile projected light for life safety, mainly comprising a casing, a projected light source and a lens body, which are installed on either inside or outside of an automobile to project light on window or ground; the characteristic lies in:
the lens body has a lens provided therein and the projected light source is installed on the rear area of the lens, thereby enabling the projected light to become a kind of warning light, character or sign picture after the light passes through the lens.

2. The automobile projected light for life safety of claim 1, wherein the lens is a cylindrical lens with a plurality of parallel cylindrical modes.

3. The automobile projected light for life safety of claim 2, wherein the lens a convex lens with a hollowed-out (pervious to light) character or sign picture printed or affixed on the surface thereof.

4. The automobile projected light for life safety of claim 1, wherein the lens is a LCD monitor pervious to light, a character or sign picture shown through the lens is controlled an integrated circuit.

5. The automobile projected light for life safety of claim 1, wherein the lens body is formed as cylindrical shape and installed on a casing to enable a driver to adjust the light projection angle; the lens body is positioned or stuck on appropriate area of an automobile by the casing, at the same time, enabling the wire of the projected light source set on the rear of the lens body to connect relevant circuits or separate control circuits of the automobile.

6. The automobile projected light for life safety of claim 5, wherein the casing comprises a stand, a mirror mount and a outer covering; the mirror mount is pivotally set on the stand, covered by the outer covering and set with the stand in one piece to position the lens body.
